(19) United States
(12) Patent Application Publication
(10) Pub. No.: US 2014/0158067 A1
(43) Pub. Date: Jun. 12, 2014

(54) VARIABLE CYCLE ENGINE

(71) Applicant: HYUNDAI MOTOR COMPANY, Seoul (KR)

(72) Inventors: Soo Hyung Woo, Yongin-si (KR); Wonjun Lee, Incheon (KR); Jei Choon Yang, Yongin-si (KR); Young Hong Kwak, Suwon-si (KR); Byong Young Choi, Bucheon-si (KR); Jin Kook Kong, Suwon-si (KR); Gee Wook Shin, Ansan-si (KR)

(73) Assignee: Hyundai Motor Company, Seoul (KR)

(21) Appl. No.: 13/870,778

(22) Filed: Apr. 25, 2013

(30) Foreign Application Priority Data
Dec. 6, 2012 (KR) 10-2012-0141287

(51) Int. Cl. F02B 69/06

(52) U.S. Cl. CPC F02B 69/06
USPC 123/21

(57) ABSTRACT

A variable cycle engine may include a first cylinder that performs an intake, a compression, an explosion, or an exhaust stroke, a second cylinder that performs an intake, a compression, an explosion, or an exhaust stroke, a connection rail that is formed near the first cylinder and the second cylinder, a first variable port that is diverged from one side of the connection rail and is connected to the first cylinder, a second variable port that is diverged from the other side of the connection rail and is connected to the second cylinder, and a first variable control valve disposed on the first variable port and a second variable control valve disposed on the second variable port, wherein the first and second variable control valves are opened or closed accordingly with respect to each other to directly connect the first cylinder with the second cylinder.

### CROSS-REFERENCE TO RELATED APPLICATION

The present application claims priority of Korean Patent Application Number 10-2012-0141287 filed Dec. 6, 2012, the entire contents of which application is incorporated herein for all purposes by this reference.

### BACKGROUND OF INVENTION

1. Field of Invention

The present invention selectively varies compression ratio of a cylinder to increase fuel consumption efficiency and simultaneously reduce vibration and noise.

2. Description of Related Art

In general, when a compression ratio is high, thermal efficiency of a heat engine increases, and when an ignition timing advances to a predetermined level in a case of an ignition engine, thermal efficiency increases.

However, when the ignition timing advances at a high compression ratio in a spark ignition engine, abnormal combustion is generated to cause damage to an engine. Accordingly, there is a limit in ignition timing advance, and it is necessary to bear output deterioration due to the limit.

The variable compression ratio (VCR) apparatus is an apparatus for changing a compression ratio of mixed gas according to an operation state of an engine. According to the variable compression ratio apparatus, fuel efficiency is improved by increasing a compression ratio of the mixed gas in a low load operation condition of the engine, and knocking generation is prevented and engine output is improved by decreasing the compression ratio of the mixed gas at a high load operation condition of the engine.

In a present diesel engine, a volume of a piston combustion chamber is increased and compression ratio is reduced to satisfy reinforced exhaust gas regulations, and low temperature combustion is realized.

However, the reduction of the compression ratio deteriorates ignition performance in a cool state, a glow system has to be ceramic material to improve the durability thereof, and a separate control unit has to be applied to control the glow system and the cost is increased. Also, the compression ratio is fixed such that the optimized compression ratio cannot be realized in accordance with various driving condition.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present disclosure has been made in an effort to provide a variable cycle engine having advantages of improving fuel efficiency and reducing vibration and noise by variably controlling compression ratio of a cylinder in accordance with a driving condition.

A variable cycle engine according to various aspects of the present invention may include a first cylinder that performs an intake, a compression, an explosion, or an exhaust stroke, a second cylinder that performs an intake, a compression, an explosion, or an exhaust stroke, a connection rail that is formed near the first cylinder and the second cylinder, a first variable port that is diverged from one side of the connection rail and is connected to the first cylinder, a second variable port that is diverged from the other side of the connection rail and is connected to the second cylinder, and a first variable control valve disposed on the first variable port and a second variable control valve disposed on the second variable port, wherein the first and second variable control valves are opened or closed accordingly with respect to each other to directly connect the first cylinder with the second cylinder.

The variable cycle engine may include a coolant jacket that surrounds the connection rail, the first variable port, or the second variable port, and a coolant that flows in the coolant jacket.

The variable cycle engine may further include an intake port that supplies a gas into the first cylinder or the second cylinder, an exhaust port that exhausts an exhaust gas from the first cylinder or the second cylinder, an intake valve that opens or closes the intake port, an exhaust valve that opens or closes the exhaust port, an intake manifold that receives the gas from an outside and distributes the gas to the intake ports, and an exhaust manifold that receives the exhaust gas from the exhaust port and exhaust the exhaust gas to the outside.

The variable cycle engine may include third and fourth cylinders that are disposed near the first and second cylinders.

An exhaust gas from the first cylinder that performs the exhaust stroke may be supplied to the second cylinder that performs the intake stroke through the first variable port, the connection rail, and the second variable port, and the first and second variable control valves are opened for a predetermined time at a predetermined timing.

A compressed gas from the first cylinder that performs a compression stroke is supplied to the second cylinder that performs an exhaust stroke through the first variable port, the connection rail, and the second variable port, and first and second variable control valves are opened for a predetermined time at a predetermined timing.

Two intake ports may be disposed at each cylinder, one exhaust port is disposed at each cylinder, and one variable port is disposed at each cylinder. Two intake ports may be disposed at each cylinder, two exhaust ports are disposed at each cylinder, and one variable port is disposed at each cylinder. The variable port may be disposed between the exhaust ports.

A control method of a variable cycle engine, which includes a first cylinder, a second cylinder, and a variable control valve disposed on a variable port that connects the first cylinder with the second cylinder, may include opening the variable control valve for a predetermined time at a predetermined timing to connect the first cylinder with the second cylinder.

The variable control valve may be opened while the first cylinder performs an exhaust stroke to supply an exhaust gas to the second cylinder that performs an intake stroke.

The variable control valve may be opened while the first cylinder performs a compression stroke to supply a compressed gas to the second cylinder that performs an exhaust stroke. Accordingly, a variable cycle engine according to various aspects of the present invention supplies another cylinder performing an exhaust stroke with a part of compression gas that is formed in a compression stroke to realize Atkinson cycle.

Accordingly, a part of exhaust gas that is formed in an exhaust stroke is supplied to another cylinder that performs an intake stroke to realize EGR (exhaust gas recirculation) system.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic top view of an interior of an exemplary variable cycle engine according to the present disclosure.

FIG. 2 is a graph showing an exemplary method for directly connecting a cylinder that performs an exhaust stroke with a cylinder that performs an intake stroke according to the present disclosure.

FIG. 3 is a graph showing an exemplary method for directly connecting a cylinder that performs a compression stroke with a cylinder that performs an exhaust stroke in a variable cycle engine according to the present disclosure.

FIG. 4 is a schematic top view of an interior of another exemplary variable cycle engine according to the present disclosure.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

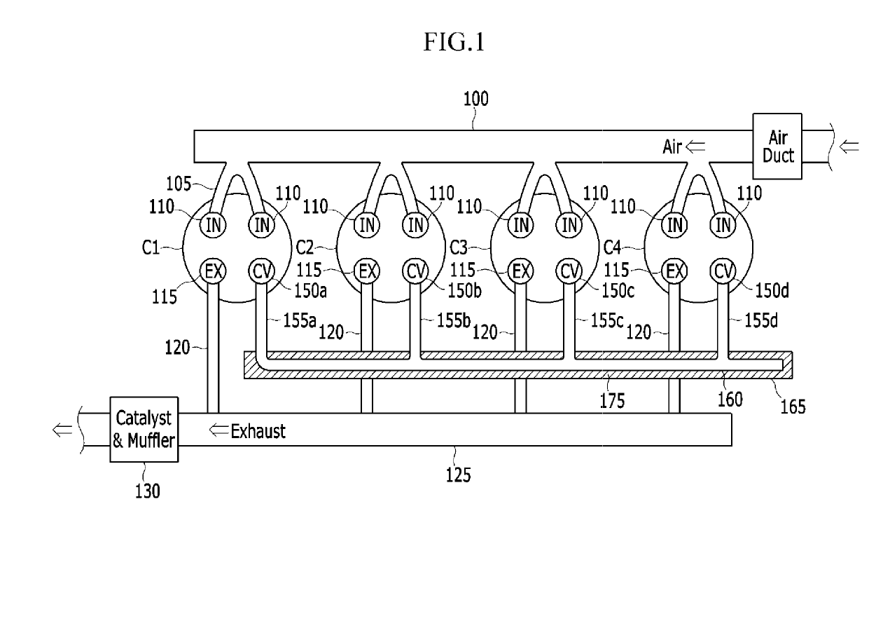

FIG. 1 is a schematic top view of an interior of an exemplary variable cycle engine according to the present disclosure. Referring to FIG. 1, a variable cycle engine includes an intake manifold 100, an intake port 105, an intake valve 110, a first cylinder C1, a second cylinder C2, a third cylinder C3, a fourth cylinder C4, an exhaust valve 115, an exhaust port 120, an exhaust manifold 125, a catalyst/muffler 130, a first variable control valve 150a, a second variable control valve 150b, a third variable control valve 150c, a fourth variable control valve 150d, a first variable port 155a, a second variable port 155b, a third variable port 155c, a fourth variable port 155d, a connection rail 160, and a coolant jacket 165.

In various embodiments of the present disclosure, an injector for injecting fuel into a cylinder or a spark plug for igniting can be disposed. The injector can be configured to be the same as or similar to any standard or conventional injectors.

Further, the present disclosure is explained based on a four cylinder engine, but the present disclosure can be applied to an engine with any number of cylinders such as two, three, five, six, eight, ten, or twelve cylinders. That is, the number of the cylinders can be variably applied.

Air outside the vehicle is distributed to the first, second, third, and fourth cylinders (C1, C2, C3, and C4) through the intake manifold 100, the intake port 105, and the intake valve 110 to be combusted with fuel. And, the combustion gas is exhausted through the exhaust valve 115, the exhaust port 120, the exhaust manifold 125, and the catalyst/muffler 130.

The first, second, third, and fourth cylinders (C1, C2, C3, and C4) respectively performs an intake, a compress, an explosion, and an exhaust stroke, and compression air of a cylinder performing compression stroke is directly supplied to a cylinder performing an exhaust stroke. Further, exhaust gas of a cylinder performing an exhaust stroke is directly supplied to a cylinder performing an intake stroke.

A connection rail 160 is disposed near the first, second, third, and fourth cylinders (C1, C2, C3, and C4), the first variable port 155a is diverged from the connection rail 160 to be connected to the first cylinder C1, the second variable port 155b is diverged from the connection rail 160 to be connected to the second cylinder C2, the third variable port 155c is diverged from the connection rail 160 to be connected to the third cylinder C3, and the fourth variable port 155d is diverged from the connection rail 160 to be connected to the fourth cylinder C4.

The first variable control valve 150a, the second variable control valve 150b, the third variable control valve 150c, and the fourth variable control valve 150d are disposed on the first, second, third, and fourth variable port (155a, 155b, 155c, 155d).

The first, second, third, and fourth variable control valves (150a, 150b, 150c, and 150d) are disposed near the exhaust valve 115, and the first, second, third, and fourth variable control valve (150a, 150b, 150c, and 150d) can be operated by a method the same as or similar to that for operating the exhaust valve 115.

But, the first, second, third, and fourth variable control valves (150a, 150b, 150c, and 150d) has no operating conditions, and the valves (150a˜150d) can have a variable valve structure or a cylinder deactivation structure (CDA).

In various embodiments of the present disclosure, a variable valve and a cylinder deactivation can be configured to be the same as or similar to any standard or conventional variable valve and cylinder deactivation.

The coolant jacket 165 is formed around the first, second, third, and fourth variable ports (155a, 155b, 155c, and 155d) or the connection rail 160 and the coolant 175 is charged in the coolant jacket 165 to be recirculated. In some embodiments of the present disclosure, the connection rail 160, the first, second, third, and fourth variable ports (155a, 155b, 155c, and 155d) and the coolant jacket 165 can be integrally formed with cylinder head or a cylinder block. One will appreciate that these may be monolithically formed. Further, the coolant jacket 165 cannot be disposed in accordance with the design specification.

In various embodiments of the present disclosure, exhaust gas that is generated from a cylinder that performs exhaust stroke is directly supplied to a cylinder that performs an intake stroke to realize an EGR system. Here, the recirculated exhaust gas can be cooled by coolant of the coolant jacket 165. Further, Atkinson cycle reducing compression ratio can be realized by directly supplying a cylinder performing exhaust stroke with exhaust gas that is generated in a compression stroke.

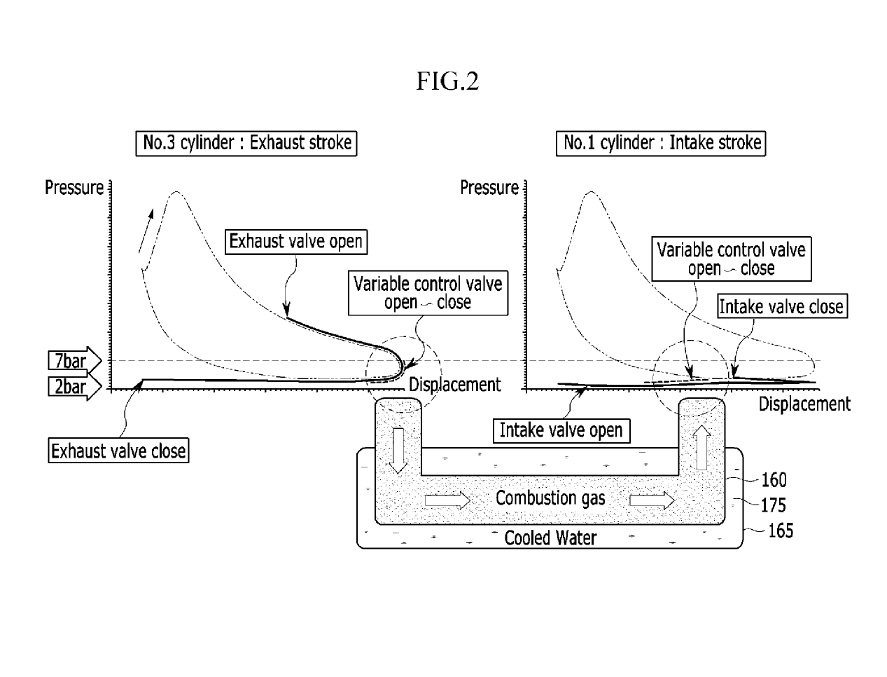

FIG. 2 is a graph showing an exemplary method for directly connecting a cylinder that performs an exhaust stroke with a cylinder that performs an intake stroke according to the present disclosure. Referring to FIG. 2, the third cylinder C3 performs an exhaust stroke, and an exhaust valve 115 that corresponds to the third cylinder C3 is opened for a predetermined period and is closed again. Here, a third variable control valve 150c that corresponds to the third cylinder C3 is opened for a predetermined period and is closed again.

And, a first cylinder C1 performs an intake stroke, and an intake valve 110 corresponding to a first cylinder C1 is opened for a predetermined period and is closed again. Here, the first variable control valve 150a corresponding to the first cylinder C1 is opened for a predetermined period and is closed again.

Accordingly, the exhaust gas of the third cylinder C3 is directly supplied to the first cylinder C1 through the third variable control valve 150c, the third variable port 155c, the connection rail 160, the first variable port 155a, and the first variable control valve 150a. Thus, the coolant jacket that surrounds the connection rail cools the exhaust gas.

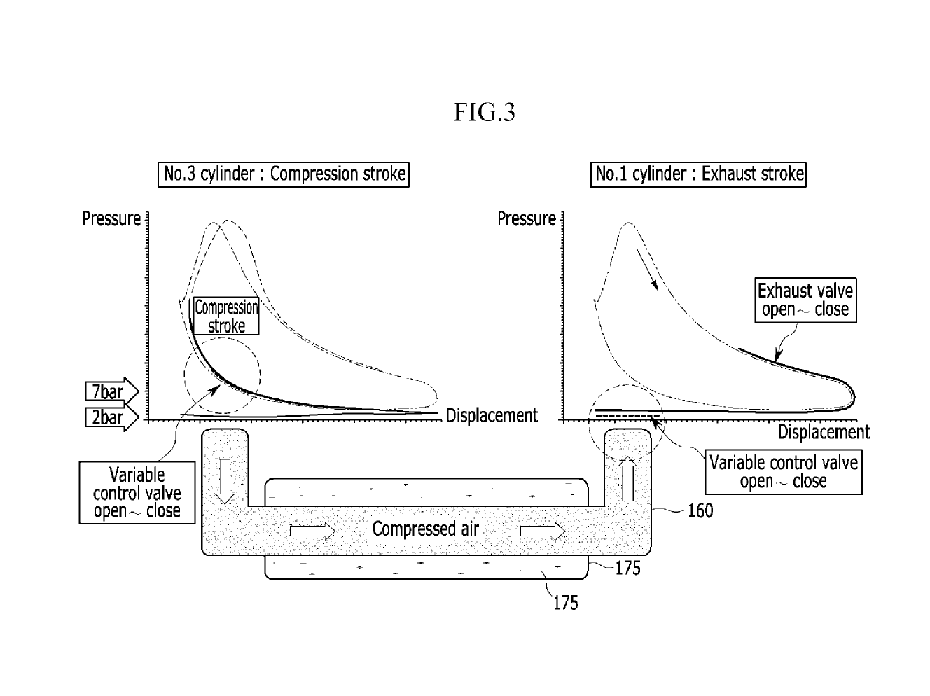

FIG. 3 is a graph showing an exemplary method for directly connecting a cylinder that performs a compression stroke with a cylinder that performs an exhaust stroke in a variable cycle engine according to the present disclosure. Referring to FIG. 3, the third cylinder C3 performs a compression stroke, and a third variable control valve 150c corresponding to the third cylinder C3 is opened for a predetermined period and is closed again.

And, the first cylinder C1 performs an exhaust stroke, and an exhaust valve corresponding to the first cylinder C1 is opened for a predetermined period and is closed again. Here, a first variable control valve 150a corresponding to the first cylinder C1 is opened for a predetermined period and is closed again.

Accordingly, a part of the compressed gas of the third cylinder C3 is directly supplied to the first cylinder C1 through the third variable control valve 150c, the third variable port 155c, the connection rail 160, the first variable port 155a, and the first variable control valve 150a.

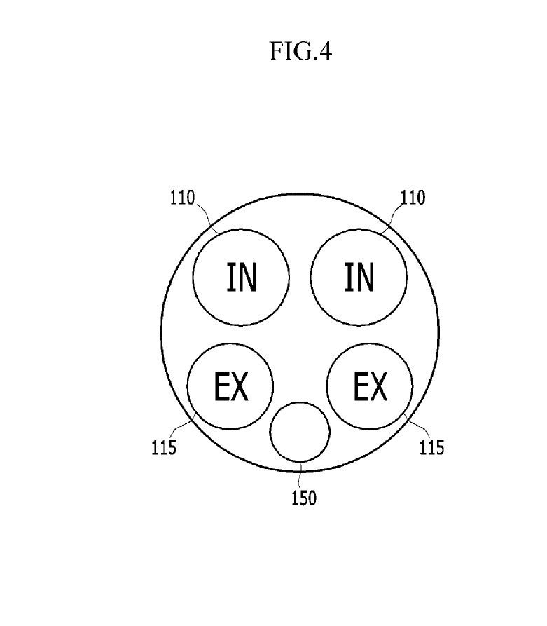

FIG. 4 is a schematic top view of an interior of another exemplary variable cycle engine according to the present disclosure. Referring to FIG. 4, two intake valves 110 are disposed at one side, two exhaust valves 115 are disposed at the other side, and the variable control valve can be disposed between the exhaust valves 115.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A variable cycle engine, comprising:
a first cylinder that performs an intake, a compression, an explosion, or an exhaust stroke;
a second cylinder that performs an intake, a compression, an explosion, or an exhaust stroke;
a connection rail that is formed near the first cylinder and the second cylinder;
a first variable port that is diverged from one side of the connection rail and is connected to the first cylinder;
a second variable port that is diverged from the other side of the connection rail and is connected to the second cylinder; and
a first variable control valve disposed on the first variable port and a second variable control valve disposed on the second variable port, wherein the first and second variable control valves are opened or closed accordingly with respect to each other to directly connect the first cylinder with the second cylinder.

2. The variable cycle engine of claim 1, further comprising a coolant jacket that surrounds the connection rail, the first variable port, or the second variable port, and a coolant that flows in the coolant jacket.

3. The variable cycle engine of claim 1, further comprising:
an intake port that supplies a gas into the first cylinder or the second cylinder;
an exhaust port that exhausts an exhaust gas from the first cylinder or the second cylinder;
an intake valve that opens or closes the intake port;
an exhaust valve that opens or closes the exhaust port;
an intake manifold that receives the gas from an outside and distributes the gas to the intake ports; and
an exhaust manifold that receives the exhaust gas from the exhaust port and exhaust the exhaust gas to the outside.

4. The variable cycle engine of claim 1, further comprising third and fourth cylinders that are disposed near the first and second cylinders.

5. The variable cycle engine of claim 1, wherein an exhaust gas from the first cylinder that performs the exhaust stroke is supplied to the second cylinder that performs the intake stroke through the first variable port, the connection rail, and the second variable port, and the first and second variable control valves are opened for a predetermined time at a predetermined timing.

6. The variable cycle engine of claim 1, wherein a compressed gas from the first cylinder that performs a compression stroke is supplied to the second cylinder that performs an exhaust stroke through the first variable port, the connection rail, and the second variable port, and first and second variable control valves are opened for a predetermined time at a predetermined timing.

7. The variable cycle engine of claim 3, wherein two intake ports are disposed at each cylinder, one exhaust port is disposed at each cylinder, and one variable port is disposed at each cylinder.

8. The variable cycle engine of claim 3, wherein two intake ports are disposed at each cylinder, two exhaust ports are disposed at each cylinder, and one variable port is disposed at each cylinder.

9. The variable cycle engine of claim 8, wherein the variable port is disposed between the exhaust ports.

10. A control method of a variable cycle engine, wherein the variable cycle engine includes a first cylinder, a second cylinder, and a variable control valve disposed on a variable port that connects the first cylinder with the second cylinder, the control method comprising:
opening the variable control valve for a predetermined time at a predetermined timing to connect the first cylinder with the second cylinder.

11. The control method of claim 10, wherein the variable control valve is opened while the first cylinder performs an exhaust stroke to supply an exhaust gas to the second cylinder that performs an intake stroke.

12. The control method of claim 10, wherein the variable control valve is opened while the first cylinder performs a compression stroke to supply a compressed gas to the second cylinder that performs an exhaust stroke.
